(19) United States
(12) Patent Application Publication
(10) Pub. No.: US 2009/0299017 A1
(43) Pub. Date: Dec. 3, 2009

(54) One-Part Type Moisture Curable Composition

(75) Inventors: Shingo Tsuno, Chigasaki (JP); Toshihide Sasaki, Kanagawa (JP)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/223,660

(22) PCT Filed: Feb. 8, 2007
(86) PCT No.: PCT/EP2007/051217

§ 371 Date: Mar. 12, 2009

(30) Foreign Application Priority Data
Feb. 8, 2006 (JP) 2006-031530

(51) Int. Cl. C08F 283/12; C08F 283/06

(52) U.S. Cl. 525/479; 525/474

(57) ABSTRACT

To provide a one-part type moisture curable composition exhibiting superior adhesion properties, weather resistance, coating tolerance, and the like, and providing good operationability, which is cured by moisture in the atmosphere to form an elastic material in the form of a rubber A one-part type moisture curable composition comprising: (A) a prepolymer having a urea bond(s), a urethane bond(s), and a hydrolysable silyl group(s) at a chain end(s) or pendent position(s) thereof; and (B) a polymer comprising a polyether structure(s) and/or a polyacryl structure(s) in the main chain, and having a hydrolysable silyl group(s) at a chain end(s) or pendent position(s) thereof.

### FIELD OF THE TECHNOLOGY

The present invention relates to a one-part type moisture curable composition which is easily cured by means of moisture, exhibits superior adhesion properties, and can be easily coated after the composition is cured.

### BACKGROUND ART

Conventionally, modified silicones, polyurethanes, and the like have been widely used as resin components in moisture curable compositions for use in sealing products, adhesives, and the like for civil engineering and construction work, automobiles, and the like, in view of superior operationability and superior adhesion properties.

Recently, in the field of civil engineering and construction work, automobiles, and the like, there is the growing need for maintaining initial performance for a long time, and in other words, “ultra-” elongation of life. Therefore, it is necessary for the sealing products, adhesives, and the like for use therein to maintain performance for a long time, such as adhesion properties, weather resistance, coating tolerance, and the like.

The sealing products, adhesives, and the like containing prepolymers for modified silicones have a low viscosity and provide good operationability, and modulus of the compositions after being cured is reduced. For these reason, they are suitable for use in sealing, but have disadvantages in that the curing rate is slightly slower, in particular, compared to that of urethane, and poor coating tolerance is exhibited.

On the other hand, the sealing products, adhesives, and the like containing prepolymers for polyurethanes have advantages in that superior adhesion properties, water resistance, and coating tolerance are exhibited, and they are relatively cheap.

As prepolymers having properties which combine the properties of the prepolymers for modified silicones and the properties of the prepolymers for polyurethanes, a prepolymer comprising a polyisocyanate and a compound containing an active hydrogen and a crosslinkable silyl group is known, as described in the specification of EP-A-596360. The aforementioned prepolymer can relatively easily be synthesized, and the sealing products, adhesives, and the like formed from the prepolymer have an advantage in that coating tolerance is increased compared to that of modified silicones. However, when the prepolymer is employed, the viscosity of the prepolymer, per se, is high, and for this reason, poor operationability is exhibited. In addition, since the modulus of the composition after being cured is increased, in particular, there is a problem in that it is difficult to apply the prepolymer to sealing.

### DISCLOSURE OF THE INVENTION

### Problems to be solved by the Invention

The present invention intends to solve the aforementioned problems in the prior art. More particularly, the present invention has an objective to provide a one-part type moisture curable composition which exhibits superior adhesion properties, weather resistance, coating tolerance, and the like, provides good operationability, and is cured by moisture in the atmosphere to form an elastic material in the form of a rubber having a suitable modulus.

### Means for Solving the Problems

The objective of the present invention can be achieved by a one-part type moisture curable composition comprising:

(A) a prepolymer having a urea bond(s), a urethane bond(s), and a hydrolysable silyl group(s) at a chain end(s) or pendent position(s) thereof; and
(B) a polymer comprising a polyether structure(s) and/or a polyacryl structure(s) in the main chain, and having a hydrolysable silyl group(s) at a chain end(s) or pendent position(s) thereof.

The aforementioned prepolymer (A) is preferably a reaction product between a first compound having an isocyanate group(s) at a chain end position(s) and an urethane bond(s) and a second compound having a hydrolysable silyl group(s) and an amino group(s). The aforementioned first compound preferably contains a polyether structure.

The main chain of the aforementioned polymer (B) preferably has both a polyether structure(s) and a polyacryl structure(s).

The aforementioned prepolymer (A) can be included in a range of from 5 to 40% by weight based on the total weight of the composition. In addition, the aforementioned polymer (B) can be included in a range of from 5 to 40% by weight based on the total weight of the composition.

The one-part type moisture curable composition of the present invention can be employed as a main component of a sealing product or an adhesive.

### EFFECTS OF THE INVENTION

The one-part type moisture curable composition of the present invention particularly exhibits superior adhesion properties, weather resistance, and coating tolerance. Therefore, when the composition of the present invention is employed, for example, as a component of a sealing product or an adhesive in the field of civil engineering and construction work, automobiles, and the like, the initial performance with respect to sealing and adhesion can be maintained for a long time. In addition, a cured material of the composition of the present invention exhibits strong adhesiveness with a coating or a paint, although the cured material contains a siloxane bond. For this reason, good coating or painting can be carried out at the sealing part and adhesion part, and the coated conditions can be maintained for a long time.

In particular, in the case where the main chain of the aforementioned polymer (B) contains both a polyether structure(s) and a polyacryl structure(s), the adhesion properties, weather resistance, and coating tolerance can be further enhanced.

### BEST MODES FOR CARRYING OUT THE INVENTION

The structure of the aforementioned prepolymer (A) having a urea bond(s) and a urethane bond(s), and having a hydrolysable silyl group(s) at a chain end(s) or pendent position(s) thereof, which is one of the essential components of the composition according to the present invention, is not particularly limited. It is preferable that a urea bond(s) and a urethane bond(s) be contained in the linear main skeleton, and a hydrolysable silyl group(s) be contained at a chain end position(s) of the molecule, and in particular, at the two chain end positions.

The hydrolysable silyl group is a group having at least one hydrolysable group directly bonded to a silicon atom. The hydrolysable group is preferably an alkoxy group, is more preferably a C₁₋₆ alkoxy group, and is, in particular, preferably a methoxy group.

The synthesis method of the aforementioned prepolymer (A) is not limited. For example, the prepolymer can be synthesized by reacting the first compound having an isocyanate group(s) at a chain end position(s) and having a urethane bond(s) with the second compound having a hydrolysable silyl group(s) and an amino group(s).

The structure of the aforementioned first compound is not particularly limited. A compound having a urethane bond(s) in a linear main skeleton and having an isocyanate group(s) at a chain end position(s) of the molecule, and in particular, at the two chain end positions, is preferable. The first compound can be prepared by, for example, reacting a polyisocyanate component and a polyol component. The aforementioned polyisocyanate component preferably contains an NCO (isocyanate) group in an amount ranging from 20% to 60%. The aforementioned polyisocyanate component can be any one of aliphatic, alicyclic, and/or aromatic polyisocyanates.

As preferable examples of the polyisocyanate components, mention may be made of toluene diisocyanate (TDI); diphenylmethane diisocyanate (MDI); triphenylmethane triisocyanate; diphenylsulfone diisocyanate; 3,3′-dimethyl-4,4′-biphenylene diisocyanate; 1,4-phenylene diisocyanate; xylene diisocyanate (XDI); tetramethylxylene diisocyanate (TMXDI); naphthylene diisocyanate; norbornane diisocyanate (NBDI); bis-(4-isocyanatecyclohexyl)methane; crude TDI; polymethylene/polyphenyl isocyanate (polymeric MDI); 1-isocyanate-3,3,5-trimethyl 5-isocyanate methylcyclohexane (isophorone diisocyanate ═IPDI); ethylene diisocyanate; propylene diisocyanate; hexamethylene diisocyanate (HDI); 1,4-tetramethylene diisocyanate; 1,5-pentamethylene diisocyanate; 2,2,4-trimethyl-1,6-hexamethylene diisocyanate; 1-isocyanate-1-methyl-4(3)-isocyanate-methylcyclohexane; hydrogenated xylene diisocyanate; 1,3-diisocyanate-6-methylcyclohexane; 1,3-diisocyanate-2-methylcyclohexane; dicyclohexylmethane diisocyanate; and isomers thereof. In addition, dimmers thereof (for example, urethodione diisocyanate) or trimers (for example, isocyanulate triisocyanate), and the like, may be mentioned. In addition, the isocyanulate products, carbodiimide products, and biuret products thereof can also be employed. In addition, mixtures thereof can also be employed. Among these, isophorone diisocyanate (IPDI), toluene diisocyanate (TDI), and mixture thereof are, in particular, preferable.

The aforementioned polyol component preferably has an average molecular weight ranging from 3,000 to 20,000 (corresponding to the OH value ranging from 37.3 to 5.6), and preferably ranging from 4,000 to 150,000 (corresponding to the OH value ranging from 28 to 7.5). As examples of the polyol component, mention may be made of, for example, ethylene glycol, propylene glycol, butylene glycol, hexylene glycol, glycerol, trimethylolpropane, pentaerythritol, sorbitol, sugar alcohol, and oligoglycols thereof, as well as mixtures thereof.

The aforementioned polyol component preferably contains a polyether structure(s). As examples of the polyol having a polyether structure(s), mention may be made of, for example, a polyoxyalkylenediol. As the polyoxyalkylenediol, diols which are known in the field of polyurethane chemistry can be employed. For example, the polyoxyalkenediol can be produced by alkoxylation such as ethoxylation or propoxylation of a diol having an appropriate starting molecular weight. As examples of the diol, mention may be made of ethylene glycol, propylene glycol, 1,3-butanediol, 1,4-butanediol, 1,6-hexanediol, 2-ethyl-1,3-hexanediol, and the like, as well as mixtures thereof. As the polyoxyalkylenediol, in particular, polyethylene glycol, polypropylene glycol, and polybutylene glycol are preferable.

The aforementioned polyoxyalkylenediol can also be produced by alkoxylation of an alkylene oxide. As examples of the preferable alkylene oxide, mention may be made of ethylene oxide, propylene oxide, and mixtures thereof. As examples of the alcohol which can be employed in the alkoxylation, mention may be made of, for example, ethylene glycol, propylene glycol, glycerol, trimethylolpropane, and polyhydric alcohols such as pentaerythritol, sorbitol, sucrose, and the like.

The aforementioned polyol component can also be produced by alkoxylation of an aliphatic amine having at least two N—H bonds. As examples of the aforementioned aliphatic amine, mention may be made of ethylamine, butylamine, and the like.

In addition, the aforementioned polyol component can be prepared from an alcohol having a low molecular weight and a polybasic carboxylic acid such as adipic acid, sebacic acid, phthalic acid, isophthalic acid, tetrahydrophthalic acid, hexahydrophthalic acid, maleic acid, anhydrides thereof, and mixture thereof. For example, polyester polyols such as polyethylene adipate and the like may be mentioned. As the polyol component, polylactones having hydroxyl groups (in particular, poly-ε-caprolactone polyol) are also preferable. In addition, polybutadiene polyols and higher fatty acid esters having hydroxyl groups such as castor oil and the like can also be employed as the polyol component.

In addition, as the aforementioned polyol component, a polymer having plural hydroxy groups, such as polyvinyl alcohol and the like can also be employed. As the polymer having plural hydroxy groups, a polymer polyol in which vinyl monomers are grafted on a polyester polyol and a polycarbonate having hydroxyl groups can also be employed.

The aforementioned first compound can be produced by reacting the polyisocyanate component and the polyol component at a temperature ranging from 40 to 120° C., and preferably ranging from 50 to 100° C. such that the NCO/OH equivalent ratio ranges from 1.3:1 to 20:1, and preferably ranges from 1.4:1 to 10:1. In the case of carrying out a chain extension via a urethane group during producing the first compound, the NCO/OH equivalent ratio is preferably selected from the range of from 1.3:1 to 2:1. In the case of not desiring the chain extension, a polyisocyanate component in excessive amounts is preferably employed, and for example, the NCO/OH equivalent ratio ranging from 4:1 to 20:1, and preferably ranging from 5:1 to 10:1 is employed. The diisocyanate in excessive amounts can be removed by, for example, distillation, after the completion of the reaction. A known catalyst such as an organic metal catalyst or an amine can be employed in the preparation of the first compound, if necessary.

The structure of the second compound having a hydrolysable silyl group(s) and an amino group(s) is not particularly limited. The hydrolysable silyl group is necessary to have at least one hydrolysable group directly bonded to a silicon atom. As the hydrolysable group, an alkoxy group is preferable, a C₁₋₆ alkoxy group is more preferable, and in particular, a methoxy group is preferable.

The preferable second compound is a compound represented by the following formula (I):

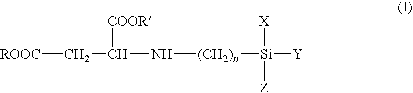

wherein
R and R′ represent the same or different alkyl groups having 1 to 8 carbon atoms and preferably having 1 to 4 carbon atoms;
X, Y and Z represent the same or different alkyl groups or alkoxy groups having 1 to 4 carbon atoms, with the proviso that at least one group thereof represents an alkoxy group; and
n represents an integer ranging from 2 to 4.

The second compound having the structure of formula (i) can be obtained as described in EP-A-596360, for example, by reacting an aminoalkylalkoxysilane represented by the following formula (II):

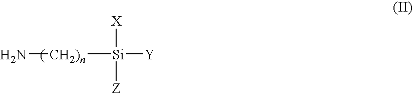

wherein
X, Y, Z and n have the same meanings as described above with a maleic ester and/or a fumaric ester represented by the following formula (III):

ROOC—CH═CH—COOR′ (III)

wherein
R and R′ have the same meanings as described above.

As examples of the preferable aminoalkylalkoxysilane, mention may be made of 3-aminopropyltrimethoxysilane, 3-aminopropyltriethoxysilane, and 3-aminopropylmethyldiethoxysilane. 3-aminopropyltrimethoxysilane and 3-aminopropyltriethoxysilane are, in particular, preferable.

The first compound and the second compound can be reacted at 0 to 60° C., and preferably at 20 to 50° C. 0.95 to 1.1 mol of the second compound is employed per mol of the NCO group of the first compound. Preferably, one mol of the second compound is employed per mol of the NCO group of the first compound. Thereby, prepolymer (A) having an average molecular weight ranging from 15,000 to 50,000 can be obtained.

The blending amount of the aforementioned prepolymer (A) in the composition of the present invention can range from 5 to 40% by weight, preferably from 5 to 30% by weight, and more preferably from 10 to 20% by weight on the basis of the total weight of the composition.

The structure of the polymer (B) comprising a polyether structure(s) and/or a polyacryl structure(s) in the main chain, and having a hydrolysable silyl group(s) at a chain end(s) or pendent position(s) thereof, which is another essential component of the composition according to the present invention, is not particularly limited. It is preferable that the polyether structure(s) and/or the polyacryl structure(s) be contained in the linear main chain, and the hydrolysable silyl group(s) be contained at a chain end position(s), and in particular, at the two chain end positions of the main chain. The hydrolysable silyl group is necessary to have at least one hydrolysable group directly bonded to a silicon atom. As the hydrolysable group, an alkoxy group is preferable, a C₁₋₆ alkoxy group is more preferable, and in particular, a methoxy group is preferable.

The aforementioned polymer (B) preferably has the main chain essentially consisting of a polyether, a (co)polymer of a (meth)acrylic acid and/or (meth)acrylic ester, or a (co)polymer of (meth)acrylic acid and/or (meth)acrylic ester and a polyether.

In particular, polymer (B) having the main chain essentially consisting of a polyether preferably contains a cross-linkable hydrolysable silyl group(s) at a chain end position(s) and contains chemically bonded repeating units, represented by general formula (1):

—(R²O)ₙ— (1)

wherein
R² represents an alkylene group having 1 to 4 carbon atoms; and
n represents an integer ranging from 10 to 10,000.

The aforementioned polymer (B) having the main chain essentially consisting of a polyether can be synthesized, for example, by reacting, in the presence of a transition metal of the VIII group, a polyalkylene oxide having an allyl group(s) at a chain end position(s) with a hydrosilane compound represented by the following formula (2)

X₃₋ₙSiR³ₙH (2)

wherein
R⁵ represents a monovalent hydrocarbon group or a halogenated monovalent hydrocarbon group;
n represents an integer of 0, 1 or 2;
X represents an atom or a group selected from a halogen atom, an alkoxy group, an acyloxy group, and a ketoxymate group.

As examples of the aforementioned polyalkylene oxide, mention may be made of, for example, polyethylene oxide, polypropylene oxide, polybutylene oxide, and the like. Polypropylene oxide is preferable since the composition can be cured at room temperature, the cured product exhibits superior water resistance, and elastic properties as a sealing product can be ensured.

When the number average molecular weight of polymer (B) is reduced, sufficient elongation of the cured product cannot be obtained, and the following capability with respect to the joint surface is reduced. On the other hand, when the number average molecular weight is increased, the viscosity before curing is increased, and operationability in the blending step may be impaired. Therefore, the number average molecular weight of polymer (B) preferably ranges from 4,000 to 30,000, and more preferably ranges from 10,000 to 30,000. In addition, the molecular weight distribution is preferably 1.6 or less.

As the aforementioned polymer (B) having the main chain essentially consisting of a polyether, for example, products of product name “MS Polymer” series (produced by Kanegafuchi Chemical Industries Co., Ltd.) such as MS Polymer S-203, MS Polymer S-303, and the like, products of product name “Sylil Polymer” series (produced by Kanegafuchi Chemical Industries Co., Ltd.) such as Sylil SAT-030, Sylil SAT-200, Sylil SAT-350, Sylil SAT-400, and the like, products of product name “Excestar” series (produced by Asahi Glass Co., Ltd.,) such as Excestar ESS-3620, Excestar ESS-3430, Excestar ESS-2420, Excestar ESS-2410, and the like are commercially available.

In order to further enhance the adhesion properties, weather resistance, coating tolerance, and the like of the composition of the present invention, the main chain of the aforementioned polymer (B) preferably contains both a polyether and a (co)polymer of a (meth)acrylic acid and/or a (meth)acrylate. As examples of acryl-modified MS polymers (hereinafter, referred to as “acryl MS polymer”) described above, mention may be made of MA 903 and MA 943 produced by Kanegafuchi Chemical Industries Co., Ltd., and the like.

The blending amount of the aforementioned polymer (B) in the composition of the present invention ranges, for example, from 5 to 40% by weight, and preferably ranges from 5 to 30% by weight, and more preferably ranges from 10 to 20% by weight, on the basis of the total weight of the composition. In particular, the ratio of the aforementioned polymer (B) and the aforementioned prepolymer (A) can range from 10:1 to 1:10, and preferably ranges from 5:1 to 1:5, more preferably ranges from 3:1 to 1:3, further preferably ranges from 2:1 to 1:2, and in particular, is preferably 1:1.

The one-part type moisture curable composition of the present invention can appropriately contain, in addition to the aforementioned components, additives such as fillers, plasticizers, thixotropy agents, solvents, pigments, coupling agents, curing catalysts, moisture absorbing agents (dehydrating agents), stabilizers, and the like, within a range which does not impair the objective of the present invention. The blending amount of the additives can range, for example, from 1 to 80% by weight, and preferably range from 1 to 60% by weight on the basis of the total weight of the composition.

As examples of the filler, mention may be made of, for example, heavy calcium carbonate, light calcium carbonate, colloidal calcium carbonate, kaolin, talc, silica, titanium oxide, aluminum silicate, magnesium oxide, zinc oxide, carbon black, glass balloon, plastic balloon, diatomaceous earth, zeolite, and the like. The aforementioned filler may be employed alone, or in combination with two or more types thereof.

As examples of the plasticizer, mention may be made of, for example, dioctyl phthalate (DOP), dibutyl phthalate (DBP), dilauryl phthalate (DLP), butylbenzyl phthalate (BBP), diisodecyl phthalate (DIDP), diisononyl phthalate (DINP), dioctyl adipate (DOA), diisononyl adipate (DINA), diisodecyl adipate, trioctyl phosphate, tris(chloroethyl)phosphate, tributyl trimellitate (TBTM), phenyl ester of alkylsulfonic acid, polyester of propyleneglycol and adipic acid, polyester of butyleneglycol and adipic acid, alkyl epoxystearate, epoxylated soybean oil, and the like. The aforementioned plasticizer may be employed alone, or in combination with two or more types thereof.

As examples of the thixotropy agent (agent for imparting thixotropic properties), mention may be made of, for example, colloidal silica, hydrogenated castor oil, organic bentonite, tribenzylidene sorbitol, surface-treated precipitated calcium carbonate, fatty acid amide wax, polyethylene wax, polyurea compound, and the like. The aforementioned thixotropy agent may be employed alone, or in combination with two or more types thereof.

The solvent can be added in order to adjust operationability. As examples thereof, mention may be made of, for example, aromatic hydrocarbons, mineral spirits, methyl ethyl ketone, and the like. The aforementioned solvent may be employed alone, or in combination with two or more types thereof.

As examples of the pigment, mention may be made of iron oxide, carbon black, phthalocyanine blue, phthalocyanine green, and the like. The aforementioned pigment may be employed alone, or in combination with two or more types thereof.

As examples of the coupling agent, mention may be made of, for example, N-(β-aminoethyl)-γ-aminopropylmethyldimethoxysilane, γ-aminopropylmethyltrimethoxysilane, γ-aminopropylmethyltriethoxysilane, vinyltrimethoxysilane, γ-glycidoxypropylmethyltrimethoxysilane, N-(β-aminoethyl)-γ-aminopropylmethyltrimethoxysilane, and the like. In addition, reaction products of two or more types of coupling agents such as aminosilane, epoxysilane, and the like (such as reaction products of various aminosilanes and epoxysilanes, condensation reaction products of coupling agents having two or more molecules with alkoxy groups) may be mentioned. The aforementioned coupling agent may be employed alone, or in combination with two or more types thereof.

As examples of the curing catalyst for prepolymer (A), mention may be made of, for example, tertiary amines such as N-methylmorpholine, triethylamine, N,N,N′,N′-tetramethylpropanediamine, bis(2-dimethylaminoethyl)ether, and the like; and organic metal compounds such as dibutyl tin dilaurate, bismuth octate, and the like. As examples of the curing catalyst for polymer (B), mention may be made of, for example, known silal condensation catalysts such as organic tin compounds, organic bismuth compounds, acidic phosphates, reaction products between acidic phosphates and amines, saturated or unsaturated polyhydric carboxylic acids or acid anhydrides thereof, aluminum chelate compounds, organic titanate compounds, and the like. The aforementioned curing catalyst may be employed alone, or in combination with two or more types thereof. As examples of the aforementioned organic tin compound, mention may be made of, for example, dibutyl tin laurate, dioctyl tin malate, dibutyl tin acetate, dibutyl tin naphthalate, tin octylate, dibutyl tin mercaptate, dibutyl tin diacetyl acetonate, dibutyl tin versatate, and the like. As examples of the aforementioned organic titanate compound, mention may be made of titanic esters such as tetrabutyl titanate, tetraisopropyl titanate, triethanolamine titanate, and the like.

As examples of the moisture absorbing agent, mention may be made of, for example, silane compounds such as vinyl trimethoxysilane, dimethyldimethoxysilane, tetraethoxysilane, methyltrimethoxysilane, methyltriethoxysilane, and the like, and isocyanate compounds such as octadecyl isocyanate, 4,4′-diphenylmethane diisocyanate, isophorone diisocyanate, 4,4′-dicyclohexylmethane diisocyanate, m-tetramethylxylylene diisocyanate, p-tetramethylxylylene diisocyanate, lysine ester triisocyanate, 1,8-diisocyanate-4-isocyanateoctane, and the like. The aforementioned moisture absorbing agent can be employed alone or in combination with two or more types thereof.

As examples of the stabilizer, mention may be made of, for example, known UV absorbing agents such as benzotriazole type, benzophenone type, and the like, antioxidants, optical stabilizers of hindered amine type, and other radical stabilizers. The aforementioned stabilizer can be employed alone or in combination with two or more types thereof.

In the one-part type moisture curable composition of the present invention, in addition to the aforementioned components, various additives such as antioxidants, antistatic agents, flame retardants, dispersants, and the like can be blended.

The one-part type moisture curable composition of the present invention can be produced by means of a known method under conditions in which the effects of moisture are controlled as much as possible (for example, under vacuum). For example, the aforementioned prepolymer (A) and polymer (B) are mixed and stirred together with various fillers, plasticizers, thixotropy agents, and the like by means of a batch type biaxial kneader or the like; subsequently, coupling agents, moisture absorbing agents, UV absorbing agents, solvents, curing catalysts, and other additives are appropriately added thereto; the mixture is further mixed and defoamed; and thereby, the objective composition can be produced.

The one-part type moisture curable composition of the present invention exhibit superior adhesion properties, weather resistance, and coating tolerance, and for this reason, the composition can be suitably applied to uses in which maintaining performance for a long time is desired. Therefore, the one-part type moisture curable composition of the present invention can be preferably employed as a component of sealing products, adhesives, or the like for use in civil engineering and construction work, automobiles, rail vehicles, marine vessels, and the like.

### EXAMPLES

In the following, the present invention is described based on Examples and Comparative Examples.

### Example 1

In a batch type biaxial kneader, a polymer having silyl terminal groups (hereinafter, referred to as “silyl group PU prepolymer”) obtained by reacting a compound of formula (1) in which all X, Y, and Z represent methoxy groups; both R and R′ represent methyl groups; and n=3, with a product (IPDI prepolymer) produced by reacting isophorone diisocyanate (IPDI) and polypropylene glycol having a molecular weight of about 12,000; acryl MS polymer (MA 903, produced by Kanegafuchi Chemical Industries Co., Ltd.); heavy calcium carbonate (NN 500, produced by Nitto Funka Kogyo Co., Ltd.); a thixotropy agent consisting of a polyurea compound; titanium oxide (TCR-10, produced by Sakai Chemical Industry Co., Ltd.); and a phthalic acid-based plasticizer (DIDP, produced by J Plus Co., Ltd.) were successively placed at room temperature. Subsequently, the mixture was stirred and kneaded under reduced pressure while heating. Subsequently, the temperature in the mixer was increased to about 70° C. to carry out dehydration by continuing stirring and kneading. Subsequently, an aminosilane (aminotrimethoxysilane/KBE-903, produced by Shin-Etsu Chemical Co., Ltd.), a dehydrating agent (methyltrimethoxysilane/KBM-13, produced by Shin-Etsu Chemical Co., Ltd.), a UV absorbing agent (LA-62, produced by Asahi Denka Corporation), and a catalyst (ECS-501, produced by Asahi Glass Urethane Co., Ltd.) were added to the reactor. The mixture was stirred and kneaded while being cooled, and then defoamed. Thereby, a one-part type moisture curable composition was produced.

### Example 2

A one-part type moisture curable composition was obtained in the same manner as described in Example 1, with the exception of replacing the acryl MS polymer with MS polymer (Excestar S2420, produced by Asahi Glass Co., Ltd.).

### Comparative Example 1

A one-part type moisture curable composition was obtained in the same manner as described in Example 1, with the exception of replacing the silyl group PU prepolymer with MS polymer.

### Comparative Example 2

A one-part type moisture curable composition was obtained in the same manner as described in Example 1, with the exception of replacing the acryl MS polymer with a silyl group PU prepolymer.

Each of the compositions according to the Examples and Comparative Examples was subjected to evaluation tests for “coating film adhesion properties”, “adhesiveness”, “operationability (discharging properties)”, “modulus strength”, and “curing properties/tack-free time”.

### Coating Film Adhesion Properties

Each of the compositions according to the Examples and Comparative Examples was applied onto a tin plate so that the thickness of the applied composition ranged from about 2 to 3 mm. 8 hours and 24 hours after the application, an acrylurethane paint (product name: Superior) produced by Nippon Paint Co., Ltd., was applied thereon. After the paint was dried for 30 minutes at 45° C., the adhesion properties of the coating film were evaluated in accordance with JIS K5400 (general coating test method). More particular, evaluation was carried out by visual observation, and in the case of exhibiting superior adhesion properties between the coating film and the composition, evaluation was ∘ (>90%); in the case of exhibiting fair adhesion properties, evaluation was Δ (30% to 75%); and in the case of exhibiting poor adhesion properties, evaluation was x (<30%).

### Adhesiveness

Each of the compositions according to the Examples and Comparative Examples was applied in the form of a bead on an aluminum plate. Subsequently, the applied part was incised by a cutter knife, and the adhesiveness of the composition with respect to the aluminum plate was visually observed. In the case of observing good adhesiveness, evaluation was Cf100 (Cf: cohesion fracture); in the case of observing poor adhesiveness, evaluation was Af100 (Af: interface peeling); and in the case of observing both good adhesiveness and poor adhesiveness, evaluation was Cf/Af. In Cf/Af, the values of Cf and Af indicate the ratio of the cohesion fracture and the interface peeling.

### Operationability (Discharging Properties)

An extrusion test was carried out in accordance with the extrusion test with a cartridge for JIS A 1439:2004 5.14 test, and the discharged amount was measured. In the case where the extrusion period was 4 or less seconds, evaluation was ∘; and in the case of exceeding 4 seconds, evaluation was x.

### Modulus Strength

A sheet having a thickness of about 2 mm was prepared from each of the compositions according to Examples 1 and 2 and Comparative Examples 1 and 2 under an atmosphere of a temperature of 20° C. and a humidity of 65%. After 7 days, a 50% modulus measurement was carried out. In the case of 0.4 MPa or less, evaluation was ∘; and in the case of exceeding 0.4 MPa, evaluation was x. In accordance with ISO 11600 sealing product classification, in class 20 LM, 60% modulus is 0.4 MPa or less.

### Curing Properties/Tack-Free Time

Under an atmosphere of a temperature of 20° C. and a humidity of 65%, each of the compositions according to Examples 1 and 2 and Comparative Examples 1 and 2 was applied onto a glass plate so that the thickness of the applied composition ranged from about 0.1 to 3.0 mm. The surface condition was observed by contacting with the fingers. In the case where the period until the composition did not adhere was 60 minutes or less, evaluation was ∘; and in the case of exceeding 60 minutes, evaluation was x.

The results are shown in Table 1. The values for the composition in the table are based on parts by weight.

### [Table 1]

TABLE 1

| | | Example | Example | Comparative | Comparative |
|---|---|---|---|---|---|
| | | 1 | 2 | Example 1 | Example 2 |
| Composition | Silyl group P U | 7.6 | 7.6 | — | 15.2 |
| | prepolymer | | | | |
| | MS polymer | — | 7.6 | 7.6 | |
| | Acryl MS polymer | 7.6 | — | 7.6 | — |
| | Heavy calcium | 13.3 | 13.3 | 13.3 | 13.3 |
| | carbonate | | | | |
| | Thixotropy agent | 15.2 | 15.2 | 15.2 | 15.2 |
| | Titanium oxide | 2.8 | 2.8 | 2.8 | 2.8 |
| | Phthalic acid-based | 0.6 | 0.6 | 0.6 | 0.6 |
| | plasticizer | | | | |
| | Aminosilane | 0.4 | 0.4 | 0.4 | 0.4 |
| | Dehydrating agent | 0.6 | 0.6 | 0.6 | 0.6 |
| | UV absorbing agent | 0.2 | 0.2 | 0.2 | 0.2 |
| | Catalyst | 0.4 | 0.4 | 0.4 | 0.4 |
| Physical | Coating adhesion | ∘ | Δ | x | Δ |
| properties | properties | | | | |
| | Adhesiveness | Cf100 | Cf50/Af50 | Cf50/Af50 | Cf20/Af80 |
| | Operationability | ∘ | ∘ | ∘ | x |
| | (discharging | | | | |
| | properties) | | | | |
| | Modulus | ∘ | ∘ | ∘ | x |
| | Curing properties/ | ∘ | ∘ | x | ∘ |
| | tack-free time | | | | |

1. A one-part type moisture curable composition comprising:
(A) a prepolymer having a urea bond(s), a urethane bond(s), and a hydrolysable silyl group(s) at a chain end(s) or pendent position(s) thereof; and
(B) a polymer comprising a polyether structure(s) and/or a polyacryl structure(s) in the main chain, and having a hydrolysable silyl group(s) at a chain end(s) or pendent position(s) thereof.

2. The composition according to claim 1, wherein the prepolymer (A) is a product of a reaction between a first compound and a second compound,
the first compound having an isocyanate group(s) at a chain end position(s), and a urethane bond(s), and
the second compound having a hydrolysable silyl group(s) and an amino group(s).

3. The composition according to claim 2, wherein the first compound comprises a polyether structure.

4. The composition according too claim 1, wherein the main chain of the polymer (B) comprises both polyether and polyacryl structures.

5. The composition according to claim 1, wherein the content of the prepolymer (A) is 5 to 40 wt % relative to the total weight of the composition.

6. The composition according to claim 1, wherein the content of the polymer (B) is 5 to 40 wt % relative to the total weight of the composition.

7. A sealing product or an adhesive comprising the composition of claim 1.
